(19) United States
(12) Patent Application Publication
(10) Pub. No.: US 2009/0327359 A1
(43) Pub. Date: Dec. 31, 2009

(54) METHOD OF CHECKING VERSION NUMBER OF ENCRYPTION INFORMATION, AND OPTICAL DISC PLAYBACK DEVICE

(75) Inventor: Shohei AOYAMA, Mito (JP)

Correspondence Address: MCDERMOTT WILL & EMERY LLP, 600 13TH STREET, N.W., WASHINGTON, DC, 20005-3096, US

(73) Assignee: HITACHI-LG DATA STORAGE, INC.

(21) Appl. No.: 12/423,580

(22) Filed: Apr. 14, 2009

(30) Foreign Application Priority Data
Jun. 30, 2008 (JP) 2008-170588

(51) Int. Cl. G06F 17/30; H04L 9/06; H04N 7/167

(52) U.S. Cl. 707/203; 713/193; 380/200

(57) ABSTRACT

In the case of a BD or the like, when encryption information used for copyright protection is updated, the version number of defective encryption information is stored into an area of a commercial medium other than the content recording area, and the user is prompted to update to a newer version number.

According to an embodiment of the present invention, the version number of encryption information on the device being used can be checked easily by the user by means of an external command. If this is a defect information version number, playback is not performed, and a display that prompts updating of the encryption information is made as required.

### CLAIM OF PRIORITY

The present application claims priority from Japanese patent application serial no. JP 2008-170588, filed on Jun. 30, 2008, the content of which is hereby incorporated by reference into this application.

### BACKGROUND OF THE INVENTION

1. Field of the Invention

The present invention relates to a method and device for playing back information that is recorded in an encrypted form for copyright protection, and more specifically to a method for facilitating management of the version number of encryption information used for the encryption.

2. Description of the Related Art

In the case of digital recording type recording and playback devices using optical media such as a DVD (Digital Versatile Disc) and a BD (Blu-Ray Disc), the quality of playback images is high, and there is very little quality degradation caused by duplication. Thus, measures for copyright protection are necessary. Encryption recording is performed so that content to be copyright-protected cannot be played back except by a specific playback device or user.

When performing encryption recording, not only encrypted content information but also the encryption key information used and the like need to be recorded in some area of a recording medium. Also, encryption information used for copyright protection are often updated to keep up with advances in technology, and to improve defects that are found in the market due to hacking or the like.

JP-A No. 2007-334939 discloses a recording method or the like for updating an encryption key on a recording medium when encryption key information is updated.

JP-A No. 2008-034002 discloses a recording and playback device or the like that stores plural pieces of copyright protection information into an area on a recording medium other than a content information recording area.

### SUMMARY OF THE INVENTION

When the above-mentioned encryption information used for copyright protection is updated, in the case of a BD or the like, defective encryption information is stored into an area other than the content recording area of a commercial medium manufactured at that time. This defective encryption information is read upon loading the medium into a playback device, and if the identification code of the encryption technology installed on the device being used matches this, playback of the commercial medium is not performed until the identification code of the encryption technology is updated. In this regard, the newer a commercial medium, the larger the version number of defective encryption information. Accordingly, a situation arises in which when attempting to play back an old commercial medium, the medium cannot be played back with a device into which a newer commercial medium was loaded before and, conversely, the medium can be played back with a device into which a newer commercial medium was not loaded before.

However, there are many conceivable causes for such a phenomenon in which the playback operation does not work, other than the version number of encryption information. Thus, even if the version number of encryption information is the cause, it is often difficult to determine as such, making it impossible for the user to take appropriate actions.

The present invention has been made in view of the above circumstances and provides a method for enhancing ease of use by making it possible to easily determine the cause of why a playback operation does not work.

According to an embodiment of the present invention, there is provided a method of checking version number of encryption information in a device that plays back encrypted recorded content containing video and audio from an optical disc recording medium that records the encrypted recorded content, including the steps of: storing version number of the encryption information into a memory; reading the version number of the encryption information stored in the memory from the memory, in response to a command from outside of the device; and notifying a user of the read version number.

According to an embodiment of the present invention, there is provided an optical disc playback device that plays back encrypted recorded content containing video and audio from an optical disc recording medium that records the encrypted recorded content, including: a playback and decryption unit that plays back the encrypted recorded content from the optical disc recording medium, and decrypts encryption by using encryption information; a storage unit that stores version number of the encryption information; a version-number-information playback unit that plays back, from the optical disc recording medium, version number information of decryption information that is defective in decrypting encryption during playback; a control unit that compares version number of encryption information as an output of the version-number-information playback unit, with the version number stored in the storage unit to determine whether or not to permit operation of the playback and decryption unit; and a display creating unit that displays the version number stored in the storage unit.

According to an embodiment of the present invention, the user can learn the version number of the encryption information on the device being used, and if a playback operation does not work due to the version number of the encryption information as its cause, the cause can be easily determined, thus allowing for enhanced ease of use.

### BRIEF DESCRIPTION OF THE DRAWINGS

These and other features, objects and advantages of the present invention will become more apparent from the following description when taken in conjunction with the accompanying drawings wherein:

FIG. 1 is a block diagram of a recording and playback device according to an embodiment of the present invention;

FIG. 2 is a plan view of an optical disc;

FIGS. 3A and 3B are diagrams showing an example of the structure of version number data according to an embodiment of the present invention;

FIG. 4 is a front view showing an example of display on a display device;

FIG. 5 is an operation flow chart showing operation according to an embodiment of the present invention;

FIG. 6 is an operation flow chart showing operation according to an embodiment of the present invention; and

FIG. 7 is an operation flow chart showing operation according to an embodiment of the present invention.

### DETAILED DESCRIPTION OF THE EMBODIMENTS

Hereinbelow, an embodiment of the present invention will be described with reference to the drawings.

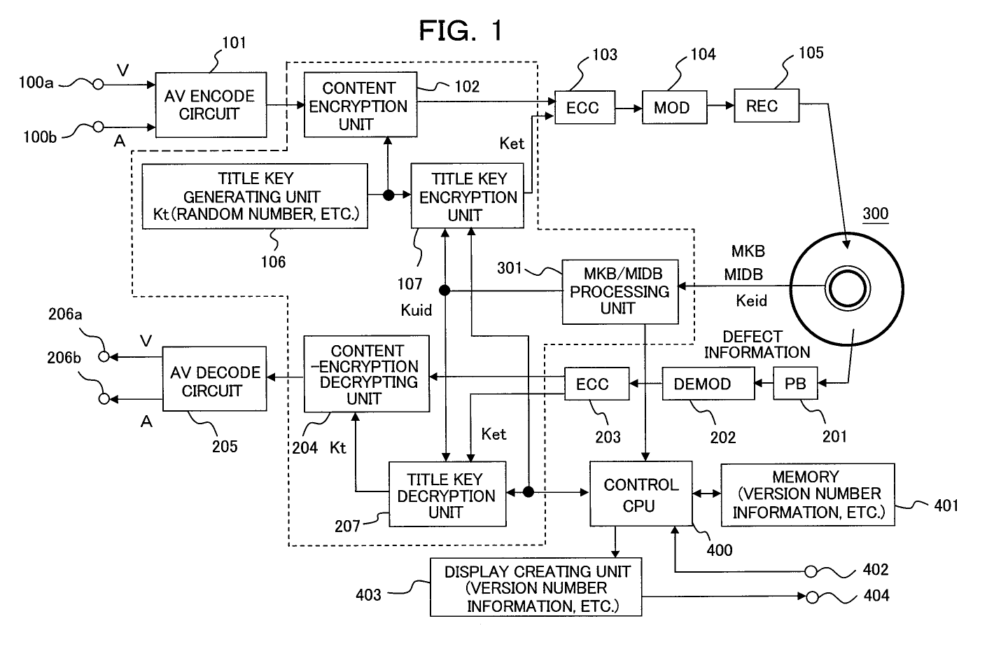

FIG. 1 is a circuit block diagram of a recording and playback device according to an embodiment of the present invention.

First, operation on the recording side will be described. The data of the video signal (V) of content to be recorded, and the data of the audio signal (A) of the same content are inputted from an input terminal 100a and an input terminal 100b, respectively. These pieces of data are each compressed in data volume using MPEG 2 (Moving Picture Experts Group 2), AC-3 (Audio Code Number 3), or the like in an AV encode circuit 101, followed by time division multiplexing, and is then encrypted using an encryption key in a content encryption unit 102, is added an error correction code, which is used for correcting errors in data during the course of recording and playback, in an ECC (Error Correction Code) circuit 103, is converted into a code suitable for recording through 8-16 modulation or the like, for example, in an MOD (modulator) circuit 104, and undergoes power amplification in an REC (Record) circuit 105, before being recorded into a content recording area of an optical disc 300. Encryption key information described later is also inputted to the ECC circuit 103, and this information is also recorded into the content recording area.

Next, a description will be given of operation of the content encryption unit 102, and the encryption key information inputted to the ECC circuit 103.

In the content encryption unit 102, content information as an output of the AV encode circuit 101 is encrypted through, for example, a scrambling process or the like, by using a title key Kt generated by a title key generating unit 106. As an example of the method of generating a title key in the title key generating unit 106, there is a method of generating a random number when recording of a title having the video data and the audio data is instructed, and using this random number as a title key.

The title key Kt used for encryption needs to be recorded onto a recording medium to decrypt the encrypted signal at the time of playing back information described later. At this time, the title key Kt is encrypted in a title key encryption unit 107 into a form that cannot be understood easily, before being recorded into the content recording area of the optical disc 300 via the ECC circuit 103 or the like. An example of such a process will be described next.

A title encryption key Kuid is supplied to the title key encryption unit 107. The title encryption key Kuid is generated on the basis of an MKB (Media Key Block), an MIDB (Media Identification Block), and an encrypted media ID (Identification) Keid which are recorded in an area of the disc other than the content recording area and read. The MKB is generated by performing a computation on a media key Km issued by the copyright holder, on the basis of a device key Kd. The MIDB is generated by performing a computation on a media unique key Kum given by the copyright holder, on the basis of plural media IDs (not shown). The Keid is generated by encrypting a media ID using the media key Km. By performing a computation on the Keid in an MKB/MIDB processing unit 301 together with the MKB and the MIDB, the title encryption key Kuid is generated.

In the title key encryption unit 107, the above-mentioned title key Kt is encrypted using the title encryption key Kuid. Therefore, a title key Ket after the encryption is generated through a composite encryption process using the key given by the copyright holder, the device key, and the like, thus rendering the original key Kt not understood easily.

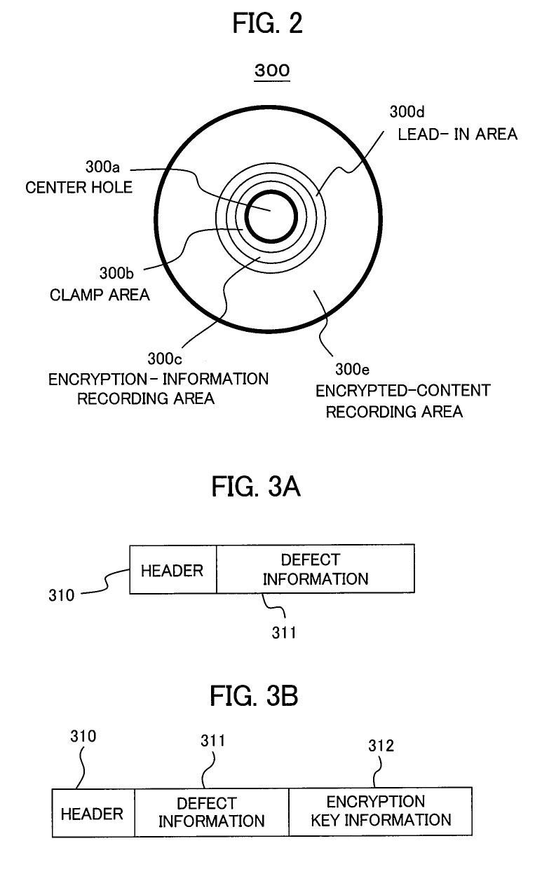

FIG. 2 is a plan view of the optical disc 300. As is well known in the art, a center hole 300a is formed at the center, and a clamp area 300b for securing the optical disc 300 at a fixed position of the drive is located in the periphery thereof. Located on the outer side of the clamp area 300b is an encryption-information recording area 300c that records encryption key information such as the above-mentioned MKB, MIDB, and Keid, and the like. The version number of defective encryption information mentioned above is also recorded in the encryption-information recording area 300c. Located on the outer side of the encryption-information recording area 300c is a lead-in area 300d that records the layout of recorded content information or the like. Further, on the outer side of the lead-in area 300d, an encrypted-content recording area 300e extends to near the outermost circumferential portion.

Next, returning to FIG. 1, operation on the playback side. Information played back from the content recording area of the optical disc 300 is amplified and equalized in amplitude and phase in a PB (Play Back) circuit 201, demodulated the 8-16 modulation or the like applied at the time of recording, for example, in a DEMOD (Demodulator) circuit 202, error-corrected the data errors that occur during recording and playback in an ECC circuit 203, decrypted encryption using the title key Kt in a content-encryption decrypting unit 204, and decompressed in an AV decode circuit 205 so that the data compression applied at the time of recording is cancelled. Thus, the original video signal data and audio signal data are outputted to output terminals 206a and 206b.

The above-mentioned title key Ket obtained after encryption is also outputted from the ECC circuit 203, and is given to a title key decryption unit 207. In the MKB/MIDB processing unit 301, a computation is performed using the MKB, MIDB, and Keid played back from the encryption-information recording area 300c of the optical disc, thereby obtaining the title encryption key Kuid mentioned above. Therefore, title key encryption is also decrypted in the title key decryption unit 207 to obtain the original title key Kt. This makes it possible to perform the decryption in the content-encryption decrypting unit 204 mentioned above.

Many of the processes in the signal processing in FIG. 1 are done by software. In particular, the portion enclosed by the broken line in the drawing which is related to encryption and decryption is often done by application software, and operation is performed after exchanging authentication with the lo drive side.

Next, a description will be given of a method of handling updating of encryption information used for copyright protection according to this embodiment. Encryption information used for copyright protection contains not only encryption key information but various kinds of information such as the methods of computation in the title key encryption unit 107 and the title key decryption unit 207. As is known in the art, new version numbers continue to be supplied to reflect advances in technology and measures against defects found in the market.

For example, in the case of commercial media recording movie software or the like, identification code information for defective playback applications is pre-recorded in the encryption-information recording area 300c of the optical disc 300 mentioned above, thus making it possible to prompt the user to update to a newer version number as required. Various structures are conceivable for such data. For example, as shown in FIG. 3A, version number information 311 on defective encryption information may be appended to a single header 310. Alternatively, as shown in FIG. 3B, both the version number information 311 on defective encryption information and the above-mentioned encryption key information 312 may be appended to the header 310, for example.

In this connection, returning to FIG. 1 again, the embodiment of the present invention will be described.

For example, when the optical disc 300 is loaded into the recording and playback device, the version number information 311 on defective encryption information, which is recorded in the encryption-information recording area 300c of the optical disc 300, is supplied to a control CPU 400 via the MKB/MIDB processing unit 301 also serving as a version-number-information playback unit, and is stored into a memory 401 connected to the control CPU 400. Next, the control CPU 400 performs authentication with respect to the playback application software enclosed by the broken line in the drawing. At this time, the control CPU 400 reads the identification code of the device's encryption information registered on the application software side and, for example, stores the identification code into the memory 401 and checks whether or not this identification code matches the identification code of defective encryption information previously stored in the memory 401. If the encryption information has already been updated to one with the latest identification code, the control CPU 400 permits playback, thus enabling transition to an encryption decrypting operation.

If the encryption information has not been updated, the control CPU 400 cannot permit playback, and instructs a display creating unit 403 to create a display for notifying the user that playback cannot be performed. The display creating unit 403 outputs the result to an output terminal 404. Thus, a display indicating that playback cannot be performed can be made on an external television, a liquid crystal panel attached to the device, or the like (not shown) which is connected to the output terminal 404.

As mentioned above, the newer a commercial medium, the larger the version number of defective encryption information recorded in the encryption-information recording area 300c. Accordingly, a situation arises in which when attempting to play back an old commercial medium, the medium cannot be played back with a device into which a new commercial medium was loaded previously and, conversely, the medium can be played back with a device into which a new commercial medium was not loaded previously. However, there are many conceivable causes for such a phenomenon in which the playback operation does not work, other than the version number of encryption information. Thus, even if the version number of encryption information is the cause, it is often difficult to determine as such, making it impossible for the user to take appropriate actions. This results in an inconvenience that playback remains impossible without the cause of such a problem being found out.

Accordingly, in this embodiment, for example, a version number check command from the user is inputted from the input terminal 402. In response to this command, the control CPU 400 reads the version number of the device's encryption information which is stored in the memory 401, for example, and outputs the version number to the display creating unit 403. The display creating unit 403 may create not only a display of the version number of the encryption information currently installed on the device but also a message prompting an update, or may create a display of the version information of defective encryption information as required. This makes it possible to notify the user of the cause of the failed playback, the necessity to update the device's encryption information, and the like in an easy-to-understand way.

This version number check command from the input terminal 402 can be inputted by the user at any arbitrary time. Version number information can be obtained at any time, not only at the time of loading an optical disc, starting its playback, or the like. This allows for significantly enhanced ease of use as compared with cases where the version number is unknown.

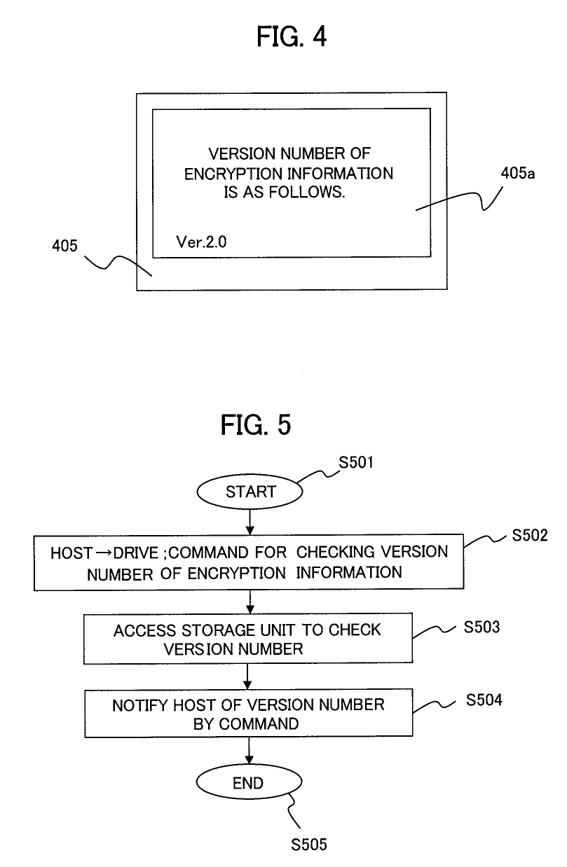

FIG. 4 shows an example of display on a display panel 405a of a display device 405 connected to the output terminal 404 shown in FIG. 1. As shown in the drawing, the version number of the encryption information currently installed on the device can be displayed. Various modifications are possible in this regard, such as displaying a message or the like that prompts an update to a newer version number.

Next, the flow of the above-mentioned operations will be described with reference to FIGS. 5 to 7. FIG. 5 is an operation flow chart according to an embodiment of the present lo invention. Symbol S denotes each operation step. The operation flow is started in step S501. In step S502, upon a user's instruction, a command for checking the version number of encryption information installed on the device is outputted from the host to the drive. In step S503, the memory is accessed to read this version number. In step S504, the host is notified of the read version number of encryption information, followed by creation of a display or the like, and the flow ends in step S505.

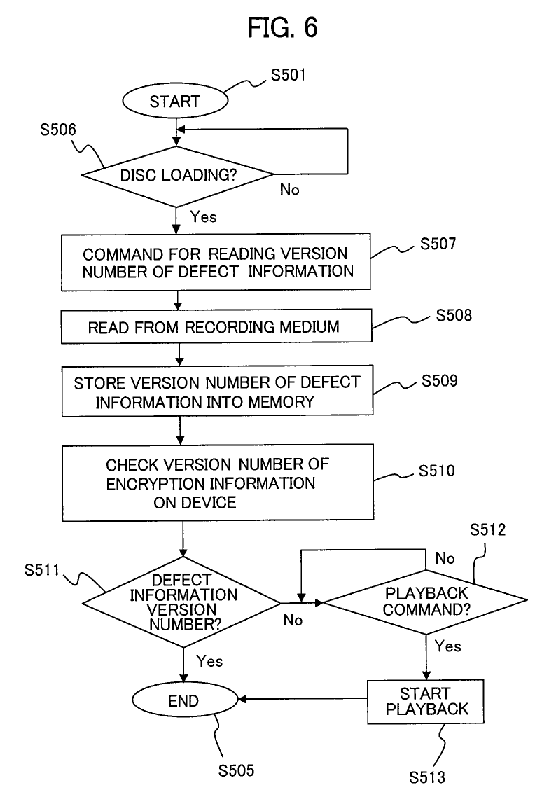

FIG. 6 shows an example of operation using the version number of defective encryption information described above. The operation flow is started in step S501. In step S506, it is checked whether or not the optical disc has been loaded. If the result is NO, the check is repeated. If the result is YES, a command for reading the version number of defective encryption information is issued in step S507. In step S508, the version number is read from the encryption-information recording area of the loaded recording medium (optical disc), and in step S509, the read version number of the defective encryption information is stored into the memory. In step S510, the version number of the encryption information installed on the device is checked. In step S511, it is determined whether or not this version number matches that of the defective encryption information. If the result is YES, the flow ends in step S511 irrespective of the presence/absence of a playback command. If the result is NO, there is no problem with the encryption information installed on the device, and thus in step S512, it is checked whether or not a playback command has been issued. If the result is NO, the check is repeated. If the result is YES, a playback operation is started in step S513, and the flow ends in step S505.

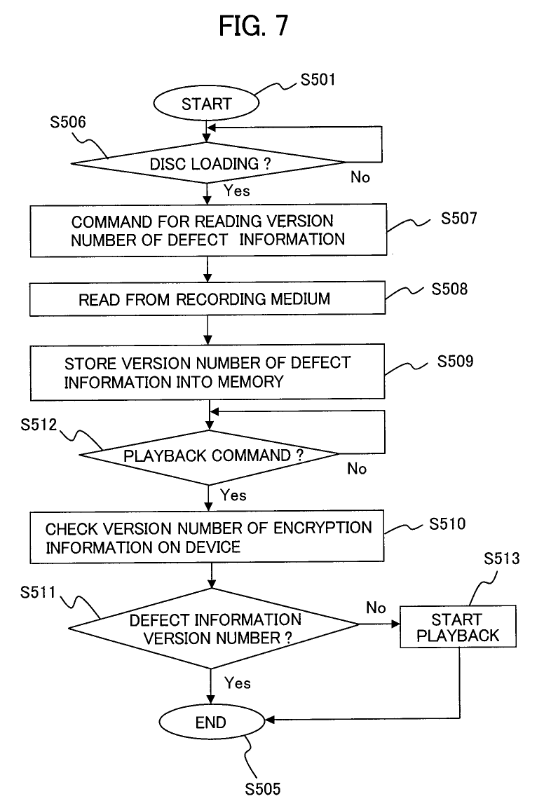

FIG. 7 shows another example of operation using the version number of defective encryption information. The difference from FIG. 6 is that the step of checking the presence/absence of a playback command is placed before step S511 that determines whether or not the encryption information is defective encryption information. Thus, although the version number of defective encryption information is checked upon the loading of the optical disc as in the case of FIG. 6, the version information of the encryption information installed on the device is checked when a playback command is inputted.

As described above, according to an embodiment of the present invention, only the version number of encryption information is disclosed without disclosing the encryption information itself such as an encryption key and the computation method used for encryption. Therefore, the confidentiality of the encryption information itself can be protected as it is in the related art.

It should be noted that while FIG. 1 does not particularly illustrate components in association with the process of giving information such as the MKB recorded in the encryption-information recording area of the optical disc 300 to the MKB/MIDB processing unit 301, this is only for simplicity of drawing. In actuality, components equivalents to a PB circuit 201, a DEMOD circuit 202, and an ECC circuit 203 may be interposed.

The present invention is not limited to a recording and playback device but is also applicable to a playback-only device that lacks a recording function. Such a playback-only device also falls within the scope of the present invention.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A method of checking version number of encryption information in a device that plays back encrypted recorded content containing video and audio from an optical disc recording medium that records the encrypted recorded content, comprising the steps of:
storing version number of the encryption information into a memory;
reading the version number of the encryption information stored in the memory from the memory, in response to a command from outside of the device; and
notifying a user of the read version number.

2. The method of checking version number of encryption information according to claim 1, further comprising the steps of:
reading version number of defective encryption information from the optical disc recording medium, when the optical disc recording medium is loaded into the device;
playing back the encrypted recorded content from the optical disc recording medium, and decrypting encryption;
comparing the version number of the defective encryption information, with the version number stored in the memory; and
determining whether or not to permit operation of the playing back and decrypting step, on the basis of a comparison result in the comparing step.

3. An optical disc playback device that plays back encrypted recorded content containing video and audio from an optical disc recording medium that records the encrypted recorded content, comprising:
a playback and decryption unit that plays back the encrypted recorded content from the optical disc recording medium, and decrypts encryption by using encryption information;
a storage unit that stores version number of the encryption information;
a version-number-information playback unit that plays back, from the optical disc recording medium, version number information of decryption information that is defective in decrypting encryption during playback;
a control unit that compares version number of encryption information as an output of the version-number-information playback unit, with the version number stored in the storage unit to determine whether or not to permit operation of the playback and decryption unit; and
a display creating unit that displays the version number stored in the storage unit.
